(19) United States
(12) Patent Application Publication
(10) Pub. No.: US 2025/0388787 A1
(43) Pub. Date: Dec. 25, 2025

(54) HOT-MELT ADHESIVE COMPOSITION, PRECOATED SURFACE MATERIAL FOR AUTOMOBILE INTERIOR, AUTOMOBILE INTERIOR MATERIAL, AND METHOD FOR PRODUCING BONDED OBJECT

(71) Applicant: Sunstar Engineering Inc., Osaka (JP)

(72) Inventors: Hideyuki KOYANAGI, Osaka (JP); Yanmei ZHANG, Osaka (JP); Seiji KATSURA, Osaka (JP)

(73) Assignee: Sunstar Engineering Inc., Osaka (JP)

(21) Appl. No.: 18/875,198

(22) PCT Filed: Jun. 15, 2023
(86) PCT No.: PCT/JP2023/022213

§ 371 Date: Dec. 16, 2024

(30) Foreign Application Priority Data
Jun. 29, 2022 (JP) 2022-104621

(51) Int. Cl. C09J 123/12

(52) U.S. Cl. CPC C09J 123/12

(57) ABSTRACT

Provided is a hot-melt adhesive as a hot-melt adhesive composition comprising: a crystalline polyolefin (A) having a Shore A hardness of 80 or more; an amorphous polyolefin (B); and a polypropylene-based wax (C), wherein the amount of the polypropylene-based wax (C) is 60 parts by weight or more and 300 parts by weight or less with respect to 100 parts by weight of the combined amount of the crystalline polyolefin (A) and the amorphous polyolefin (B), and the hot-melt adhesive has good adhesiveness to a resin base material, particularly a polyolefin base material including a polypropylene base material, and also has workability (mold releasability) that allows easy peeling from a mold.

### TECHNICAL FIELD

The present disclosure relates to a hot-melt adhesive composition, a precoated surface material for an automobile interior containing the same, and an automobile interior material.

### BACKGROUND ART

A hot-melt adhesive is solid at ambient temperature, is heated and melted to be applied to a base material and bonds the base materials to each other by cooling and solidification. The hot-melt adhesive has advantages such as reduction in VOC and improvement of productivity by omission of a drying process as compared with a solvent-based adhesive, and is used for various applications such as automobile manufacturing applications.

Patent Document 1 discloses a hot-melt adhesive composition containing a hydrocarbon-based cyclic polymer, an α-olefin-based polymer, and a tackifier resin.

Patent Document 2 discloses a hot-melt adhesive composition containing an α-olefin copolymer polymerized using a multisite catalyst, an α-olefin copolymer polymerized using a single site catalyst, an ethylene-polar group-containing monomer copolymer, a hydrogenated tackifier resin, and a polypropylene-based wax at a specific ratio.

### PRIOR ART DOCUMENTS

### Patent Documents

Patent Document 1: WO 2018/012593
Patent Document 2: WO 2018/100672

### SUMMARY OF THE INVENTION

### Problems to be Solved by the Invention

When a hot-melt adhesive is used, a step of peeling the hot-melt adhesive from a mold (for example, a vacuum forming process) is required depending on the type of adhesion methods. In Patent Document 1 and Patent Document 2, the step of peeling a hot-melt adhesive from a mold is not examined. A conventional hot-melt adhesive takes time to solidify from a molten state, the hot-melt adhesive cannot be easily peeled from the mold during that time, and therefore, the hot-melt adhesive may have poor workability. In addition, use of a conventional hot-melt adhesive may cause a problem from the viewpoint of workability because the hot-melt adhesive remains after peeling from a mold, and manual peeling, cleaning, and the like are required.

Therefore, an object of the present disclosure is to provide a hot-melt adhesive having good adhesiveness to a resin base material, particularly a polyolefin base material including a polypropylene base material, and also having workability that enables easy peeling from a mold (mold releasability).

### Solutions to the Problems

That is, the present disclosure includes the following.

### [Item 1]

A hot-melt adhesive composition comprising:
a crystalline polyolefin (A) having a Shore A hardness of 80 or more;
an amorphous polyolefin (B); and
a polypropylene-based wax (C),
wherein an amount of the polypropylene-based wax (C) is 60 parts by weight or more and 300 parts by weight or less with respect to 100 parts by weight of a combined amount of the crystalline polyolefin (A) and the amorphous polyolefin (B).

### [Item 2]

The hot-melt adhesive composition according to item 1, wherein the crystalline polyolefin (A) has a melting point of 80° C. or higher.

### [Item 3]

The hot-melt adhesive composition according to item 1 or 2, wherein the crystalline polyolefin (A) contains an ethylene-propylene copolymer.

### [Item 4]

The hot-melt adhesive composition according to any one of items 1 to 3, wherein the amorphous polyolefin (B) has a softening point of 100° C. or higher.

### [Item 5]

The hot-melt adhesive composition according to any one of items 1 to 4, wherein the amorphous polyolefin (B) includes at least one selected from the group consisting of an ethylene-propylene bipolymer and an ethylene-propylene-butene terpolymer.

### [Item 6]

The hot-melt adhesive composition according to any one of items 1 to 5, wherein the polypropylene-based wax (C) has a softening point of 130° C. or higher.

### [Item 7]

The hot-melt adhesive composition according to any one of items 1 to 6, comprising a tackifier (D).

### [Item 8]

The hot-melt adhesive composition according to item 7, wherein the tackifier (D) has a softening point of 90° C. or higher.

### [Item 9]

The hot-melt adhesive composition according to item 7, wherein the tackifier (D) includes at least one selected from the group consisting of a hydrogenated petroleum resin, a terpene resin, and a terpene phenol resin.

### [Item 10]

The hot-melt adhesive composition according to any one of items 1 to 9, comprising an antioxidant (E).

### [Item 11]

The hot-melt adhesive composition according to any one of items 1 to 10, comprising an inorganic filler (F).

### [Item 12]

The hot-melt adhesive composition according to any one of items 1 to 11, comprising an elastomer (G).

### [Item 13]

The hot-melt adhesive composition according to any one of items 1 to 12, having a melt viscosity at 180° C. of 15,000 mPa·s or more and 100,000 mPa·s or less.

### [Item 14]

The hot-melt adhesive composition according to any one of items 1 to 13, which is for an automobile interior material.

### [Item 15]

A precoated surface material for an automobile interior, the precoated surface material comprising: a surface material for an automobile interior; and a hot-melt adhesive layer formed from the hot-melt adhesive composition according to any one of items 1 to 14 and provided on a back surface of the surface material for an automobile interior.

### [Item 16]

An automobile interior material comprising: a molded article for an automobile interior; and the precoated surface material for an automobile interior according to item 15 that is bonded to the molded article for an automobile interior with the hot-melt adhesive layer interposed therebetween.

### [Item 17]

A method for producing a bonded object,
the bonded object having a first base material and a second base material bonded to the first base material with a hot-melt adhesive layer formed from the hot-melt adhesive composition according to any one of items 1 to 14 interposed therebetween,
the method comprising a step of bringing a mold into contact with the hot-melt adhesive composition.

### Effects of the Invention

The hot-melt adhesive of the present disclosure has good adhesiveness particularly to a polyolefin base material including a polypropylene base material, and also has good mold releasability, and is excellent in workability.

### DETAILED DESCRIPTION

### <Hot-Melt Adhesive Composition>

The hot-melt adhesive composition of the present disclosure contains a crystalline polyolefin (A), an amorphous polyolefin (B), and a polypropylene-based wax (C). The hot-melt adhesive composition of the present disclosure can further contain, in addition to (A) to (C), one or more selected from a tackifier (D), an antioxidant (E), an inorganic filler (F), an elastomer (G), a plasticizer (H), other additives (I), and the like as necessary.

### [(A) Crystalline Polyolefin]

The hot-melt adhesive composition of the present disclosure contains a crystalline polyolefin (A). The crystalline polyolefin (A) is a high crystalline polyolefin. The crystalline polyolefin (A) is distinguished from other components described herein in terms of crystallinity, Shore A hardness, and/or molecular weight, and the like. Typically, the crystalline polyolefin (A) has a crystallinity of 20% or more. Typically, the crystalline polyolefin (A) has a Shore A hardness of 80 or more. Typically, the crystalline polyolefin (A) has a weight-average molecular weight of 40,000 or more.

The crystallinity of the crystalline polyolefin (A) may be 20% or more, 25% or more, 30% or more, or 35% or more. The crystallinity of the crystalline polyolefin (A) may be 100% or less, 98% or less, 95% or less, 90% or less, or 85% or less. The crystallinity equal to or more than the above-mentioned lower limit is preferable from the viewpoint of more favorably exhibiting the effects of the present disclosure. The crystallinity can be measured by, for example, differential scanning calorimetry or X-ray diffraction of a polymer. The term “crystalline” in the present disclosure may mean a property in which a clear endothermic peak derived from a crystal portion is observed in differential scanning calorimetry, whereas the term “amorphous” may mean a property in which a clear endothermic peak derived from a crystal portion is not observed in differential scanning calorimetry.

The Shore A hardness of the crystalline polyolefin (A) may be 80 or more, 85 or more, 90 or more, or 95 or more, and is preferably 85 or more, more preferably 90 or more. The Shore A hardness of the crystalline polyolefin (A) may be 100 or less, 99 or less, 98 or less, or 97 or less. The Shore A hardness can be used as an index of the cohesive force of the resin, and may serve as one of indices of adhesiveness at room temperature and hot temperature. The Shore A hardness within the above-mentioned range is preferable from the viewpoint of more favorably exhibiting the effects of the present disclosure.

The melting point of the crystalline polyolefin (A) may be 60° C. or higher, 70° C. or higher, 80° C. or higher, 90° C. or higher, 100° C. or higher, or 110° C. or higher, and is preferably 80° C. or higher. The melting point of the crystalline polyolefin (A) may be 150° C. or lower, 140° C. or lower, 130° C. or lower, 120° C. or lower, 110° C. or lower, 100° C. or lower, or 90° C. or lower, and is preferably 120° C. or lower, for example, 110° C. or lower, or 100° C. or lower. The melting point within the above-mentioned range is preferable from the viewpoint of more favorably exhibiting the effects of the present disclosure.

The glass transition temperature of the crystalline polyolefin (A) may be −150° C. or higher, −125° C. or higher, −100° C. or higher, −75° C. or higher, −50° C. or higher, or −25° C. or higher. The glass transition temperature of the crystalline polyolefin (A) may be 20° C. or lower, 10° C. or lower, 0° C. or lower, −10° C. or lower, or −20° C. or lower, and is preferably 0° C. or lower, more preferably −10° C. or lower. The glass transition temperature equal to or less than the above-mentioned upper limit is preferable from the viewpoint of low-temperature adhesiveness.

The crystalline polyolefin (A) is typically thermoplastic. The MFR of the crystalline polyolefin (A) may be 3 g/10 min or more, 5 g/10 min or more, 7 g/10 min or more, 10 g/10 min or more, 12 g/10 min or more, or 15 g/10 min or more, and is preferably 5 g/10 min or more, more preferably 7 g/10 min or more. The MFR of the crystalline polyolefin (A) may be 40 g/10 min or less, 30 g/10 min or less, 20 g/10 min or less, 15 g/10 min or less, or 10 g/10 min or less. The MFR within the range equal to or more than the above-mentioned lower limit is preferable from the viewpoint of the low melt viscosity and coating stability. The MFR can be measured according to JIS K7210.

The weight-average molecular weight of the crystalline polyolefin (A) may be 40,000 or more, 50,000 or more, 75,000 or more, 100,000 or more, 200,000 or more, 300,000 or more, or 500,000 or more, and is preferably 100,000 or more. The weight-average molecular weight of the crystalline polyolefin (A) may be 5,000,000 or less, 2,000,000 or less, 1,500,000 or less, 1,200,000 or less, 1,000,000 or less, 800,000 or less, 600,000 or less, 400,000 or less, or 200,000 or less, and is preferably 1,000,000 or less, for example, 600,000 or less. The weight-average molecular weight within the above-mentioned range is preferable from the viewpoint of more favorably exhibiting the effects of the present disclosure.

The crystalline polyolefin (A) is a polymer having a repeating unit derived from an olefin. The crystalline polyolefin (A) is preferably an α-olefin-based polymer having a repeating unit derived from an α-olefin, particularly an α-olefin-based copolymer. The crystalline polyolefin (A) may be a homopolymer, a copolymer, or a mixture thereof. The form of the copolymer may be any of random copolymer, block copolymer, graft copolymer, and the like.

Examples of the repeating unit contained in the crystalline polyolefin (A) include repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be contained alone or in combination of two or more.

The crystalline polyolefin (A) preferably contains a repeating unit derived from propylene among the repeating units described above, and may contain, for example, both a repeating unit derived from propylene and a repeating unit derived from another α-olefin (for example, ethylene). Among the repeating units that constitute the crystalline polyolefin (A), the repeating units derived from propylene may account for 20 mol % or more, 30 mol % or more, 40 mol % or more, 50 mol % or more, 60 mol % or more, or 70 mol % or more, and preferably account for 30 mol % or more.

Examples of the crystalline polyolefin (A) include olefin-olefin copolymers such as an ethylene homopolymer, a propylene homopolymer, an ethylene-propylene copolymer, a propylene-1-butene copolymer, an ethylene-1-butene copolymer, an ethylene-1-octene copolymer, an ethylene-1-hexene copolymer, and an ethylene-propylene-1-butene copolymer, and preferable examples include an ethylene-propylene copolymer. These may be used alone or in combination of two or more.

Examples of representative commercially available products of the crystalline polyolefin (A) include TAFMER series manufactured by Mitsui Chemicals, Inc. under the trade names of “TAFMER XM-7090”, “TAFMER XM-7080”, “TAFMER XM-7070”, “TAFMER XM-5090”, “TAFMER XM-5080”, “TAFMER XM-5070”, “TAFMER BL-2491M”, “TAFMER DF110”, and the like; VERSIFY series manufactured by The Dow Chemical Co. under the trade names of “VERSIFY 3000”, “VERSIFY 4200”, and the like; Vistamaxx series manufactured by Exxon Mobil Corporation under the trade names of “Vistamaxx 8880”, “Vistamaxx 3000” “Vistamaxx 3980FL”, and the like; and “L-MODU S901”, “L-MODU S600” and “L-MODU S400” manufactured by Idemitsu Kosan Co., Ltd.. The crystalline polyolefin (A) may be used alone or in combination of two or more.

### [(B) Amorphous Polyolefin]

The hot-melt adhesive composition of the present disclosure contains an amorphous polyolefin (B). The amorphous polyolefin (B) is a non-crystalline or low crystalline polyolefin and can impart flexibility. The amorphous polyolefin (B) is distinguished from other components described herein in terms of crystallinity, and/or molecular weight, and the like. Typically, the amorphous polyolefin (B) has a crystallinity of less than 20%. Typically, the amorphous polyolefin (B) has a weight-average molecular weight of 40,000 or more.

The crystallinity of the amorphous polyolefin (B) may be 0% or more, 3% or more, or 5% or more. The crystallinity of the amorphous polyolefin (B) may be less than 20%, 15% or less, 10% or less, 5% or less, 3% or less, or 1% or less. The crystallinity equal to or less than the above-mentioned upper limit is preferable from the viewpoint of more favorably exhibiting the effects of the present disclosure. The crystallinity can be measured by, for example, differential scanning calorimetry or X-ray diffraction of a polymer.

The softening point of the amorphous polyolefin (B) may be 70° C. or higher, 80° C. or higher, 90° C. or higher, 100° C. or higher, 110° C. or higher, 120° C. or higher, or 130° C. or higher, and is preferably 80° C. or higher, for example, 100° C. or higher. The softening point of the amorphous polyolefin (B) may be 180° C. or lower, 170° C. or lower, 160° C. or lower, 150° C. or lower, 140° C. or lower, 130° C. or lower, 120° C. or lower, or 110° C. or lower, and is preferably 160° C. or lower, for example, 140° C. or lower. The softening point within the above-mentioned range is preferable from the viewpoint of more favorably exhibiting the effects of the present disclosure. The softening point can be measured by a ring and ball method.

The glass transition temperature of the amorphous polyolefin (B) may be −150° C. or higher, −125° C. or higher, −100° C. or higher, −75° C. or higher, −50° C. or higher, or −25° C. or higher. The glass transition temperature of the amorphous polyolefin (B) may be 20° C. or lower, 10° C. or lower, 0° C. or lower, −10° C. or lower, or −20° C. or lower, and is preferably 0° C. or lower, more preferably −10° C. or lower. The glass transition temperature equal to or less than the above-mentioned upper limit is preferable from the viewpoint of low-temperature adhesiveness.

The amorphous polyolefin (B) is typically thermoplastic. The MFR of the amorphous polyolefin (B) may be 3 g/10 min or more, 5 g/10 min or more, 7 g/10 min or more, 10 g/10 min or more, 12 g/10 min or more, or 15 g/10 min or more, and is preferably 5 g/10 min or more, more preferably 7 g/10 min or more. The MFR of the amorphous polyolefin (B) may be 40 g/10 min or less, 30 g/10 min or less, 20 g/10 min or less, 15 g/10 min or less, or 10 g/10 min or less. The MFR within the range equal to or more than the above-mentioned lower limit is preferable from the viewpoint of the low melt viscosity and coating stability. The MFR can be measured according to JIS K7210.

The weight-average molecular weight of the amorphous polyolefin (B) may be 40,000 or more, 50,000 or more, 75,000 or more, 100,000 or more, 200,000 or more, 300,000 or more, or 500,000 or more, and is preferably 100,000 or more. The weight-average molecular weight of the amorphous polyolefin (B) may be 5,000,000 or less, 2,000,000 or less, 1,500,000 or less, 1,200,000 or less, 1,000,000 or less, 800,000 or less, 600,000 or less, 400,000 or less, or 200,000 or less, and is preferably 1,000,000 or less, for example, 600,000 or less. The weight-average molecular weight within the above-mentioned range is preferable from the viewpoint of more favorably exhibiting the effects of the present disclosure.

The amorphous polyolefin (B) is a polymer having a repeating unit derived from an olefin. The amorphous polyolefin (B) is preferably an α-olefin-based polymer having a repeating unit derived from an α-olefin, particularly an α-olefin-based copolymer. The amorphous polyolefin (B) may be a homopolymer, a copolymer, or a mixture thereof. The form of the copolymer may be any of random copolymer, block copolymer, graft copolymer, and the like.

Examples of the repeating unit contained in the amorphous polyolefin (B) include repeating units derived from ethylene, propylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be contained alone or in combination of two or more.

The amorphous polyolefin (B) preferably contains a repeating unit derived from propylene among the repeating units described above, and may contain, for example, both a repeating unit derived from propylene and a repeating unit derived from another α-olefin (for example, ethylene). Among the repeating units that constitute the amorphous polyolefin (B), the repeating units derived from propylene may account for 20 mol % or more, 30 mol % or more, 40 mol % or more, 50 mol % or more, 60 mol % or more, or 70 mol % or more, and preferably account for 30 mol % or more.

Examples of the amorphous polyolefin (B) include olefin-olefin copolymers such as an ethylene homopolymer, a propylene homopolymer, an ethylene-propylene copolymer, a propylene-1-butene copolymer, an ethylene-1-butene copolymer, an ethylene-1-octene copolymer, an ethylene-1-hexene copolymer, and an ethylene-propylene-1-butene copolymer, and preferable examples include an ethylene-propylene bipolymer and/or an ethylene-propylene-butene terpolymer. These may be used alone or in combination of two or more.

Examples of representative commercially available products of the amorphous polyolefin (B) include VESTOPLAST series manufactured by Evonik Industries AG under the trade names of “VESTOPLAST 308”, “VESTOPLAST 508”, “VESTOPLAST 520”, “VESTOPLAST 608”, “VESTOPLAST EP V2103”, “VESTOPLAST EP V2094”, “VESTOPLAST 708”, “VESTOPLAST 750”, “VESTOPLAST 751”, “VESTOPLAST 792”, “VESTOPLAST 828”, “VESTOPLAST 888”, “VESTOPLAST 891”, “VESTOPLAST EP 807”, and the like; and RT series manufactured by REXtac, LLC under the trade names of “RT 2280”, “RT 2385”, “RT 2585”, “RT 2780”, and the like.

### [(C) Polypropylene-Based Wax]

The hot-melt adhesive composition of the present disclosure contains a polypropylene-based wax (C). The polypropylene-based wax (C) is a wax having a repeating unit derived from propylene. The polypropylene-based wax (C) generally has a low molecular weight (less than 40,000) and can impart coating property and wettability to an adherend by lowering the viscosity of the hot-melt adhesive. In addition, the polypropylene-based wax (C) may promote crystallization and solidification of the crystalline polyolefin (A), improve the solidification rate of the hot-melt adhesive, and improve the mold peelability.

The softening point of the polypropylene-based wax (C) is 90° C. or higher, 100° C. or higher, 110° C. or higher, 120° C. or higher, 130° C. or higher, 140° C. or higher, or 150° C. or higher, preferably 110° C. or higher, more preferably 120° C. or higher, and still more preferably 130° C. or higher. The softening point of the polypropylene-based wax (C) may be 220° C. or lower, 210° C. or lower, 190° C. or lower, 180° C. or lower, 170° C. or lower, 160° C. or lower, or 150° C. or lower, and is preferably 190° C. or lower, for example, 160° C. or lower. The softening point within the above-mentioned range is preferable from the viewpoint of more favorably exhibiting the effects of the present disclosure. The softening point can be measured by a ring and ball method. The softening point of the polypropylene-based wax (C) equal to or less than the above-mentioned upper limit is preferable from the viewpoint that the melting temperature can be set low, and the working time is shortened.

The weight-average molecular weight of the polypropylene-based wax (C) may be 3,000 or more, 5,000 or more, or 7,000 or more, and is preferably 3,000 or more. The weight-average molecular weight of the polypropylene-based wax (C) may be less than 40,000, 35,000 or less, 30,000 or less, 20,000 or less, or 10,000 or less, and is preferably 20,000 or less. The weight-average molecular weight within the above-mentioned range is preferable from the viewpoint of more favorably exhibiting the effects of the present disclosure.

The polypropylene-based wax (C) may have a repeating unit other than the repeating unit derived from propylene, for example, a repeating unit derived from an α-olefin. The polypropylene-based wax (C) may be a low molecular weight polyolefin, particularly a low molecular weight α-olefin-based polymer. The polypropylene-based wax (C) may be a homopolymer, a copolymer, or a mixture thereof. The form of the copolymer may be any of random copolymer, block copolymer, graft copolymer, and the like.

Examples of the repeating unit contained in the polypropylene-based wax (C) other than the repeating unit derived from propylene include repeating units derived from ethylene, 1-butene, 1-pentene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, and the like, and these repeating units may be contained alone or in combination of two or more.

Among the repeating units that constitute the polypropylene-based wax (C), the repeating units derived from propylene may account for 20 mol % or more, 30 mol % or more, 40 mol % or more, 50 mol % or more, 60 mol % or more, or 70 mol % or more, and preferably account for 30 mol % or more.

Examples of representative commercially available products of the polypropylene-based wax (C) include VISCOL series manufactured by Sanyo Chemical Industries, Ltd. under the trade names of “VISCOL 660-P”, “VISCOL 550-P”, “VISCOL 440-P”, “VISCOL 330-P”, and the like; Hi-WAX series manufactured by Mitsui Chemicals, Inc. under the trade names of “Hi-WAX 100 P”, “Hi-WAX 200 P”, “Hi-WAX 400 P”, “Hi-WAX 800 P”, “Hi-WAX 410 P”, “Hi-WAX 420 P”, and the like; and Licocene series manufactured by Clariant Plastics & Coatings (Japan) K. K. under the trade names of “Licocene PP 6102”, “Licocene PP 6502” and “Licocene PP 7502”. The polypropylene-based wax (C) may be used alone or in combination of two or more. Furthermore, a wax other than the polypropylene-based wax (C) may be blended within a range in which various intended physical properties are not impaired.

### [(D) Tackifier]

The hot-melt adhesive composition of the present disclosure may contain a tackifier (D). The tackifier (D) may improve tackiness at melting.

The softening point of the tackifier (D) is 90° C. or higher, 100° C. or higher, 110° C. or higher, 120° C. or higher, 130° C. or higher, 140° C. or higher, or 150° C. or higher, preferably 110° C. or higher, more preferably 120° C. or higher, and still more preferably 130° C. or higher. The softening point of the tackifier (D) may be 220° C. or lower, 210° C. or lower, 190° C. or lower, 180° C. or lower, 170° C. or lower, 160° C. or lower, or 150° C. or lower, and is preferably 190° C. or lower, for example, 160° C. or lower. The softening point within the above-mentioned range is preferable from the viewpoint of more favorably exhibiting the effects of the present disclosure. The softening point can be measured by a ring and ball method. The softening point of the tackifier (D) equal to or less than the above-mentioned upper limit is preferable from the viewpoint that the melting temperature can be set low, and the working time is shortened.

Examples of the tackifier (D) include a rosin resin, a rosin ester, a disproportionated rosin ester, a hydrogenated rosin ester, a polymerized rosin, an aliphatic hydrocarbon resin, an aliphatic aromatic copolymer resin, an aromatic petroleum resin, a hydrogenated petroleum resin, a terpene resin, a hydrogenated terpene resin, a modified terpene resin, a hydrogenated product of a modified terpene resin, a terpene phenol resin, a hydrogenated terpene phenol resin, a styrene-based resin, a coumarone resin, and an indene resin. Among these, from the viewpoint of compatibility with a polyolefin, preferable examples include a hydrogenated petroleum resin, a terpene resin, and a terpene phenol resin. The tackifier (D) is distinguished from other components such as a polyolefin from the viewpoint of the presence or absence of an intramolecular double bond, the presence or absence of an intramolecular polar group, an intramolecular hydrocarbon group, and the like.

Examples of representative commercially available products of the tackifier (D) include ARKON series manufactured by Arakawa Chemical Industries, Ltd. under the trade names of “ARKON P-90”, “ARKON P-100”, “ARKON P-115”, “ARKON P-140”, “ARKON M-90”, “ARKON M-100”, “ARKON M-115”, “ARKON M-135”, and the like; “Imarb” series manufactured by Idemitsu Kosan Co., Ltd. under the trade names of “Imarb S-100”, “Imarb S-110”, “Imarb P-100”, “Imarb P-125”, “Imarb P-140”, and the like; T-REZ series manufactured by ENEOS Corporation such as “T-REZ HA125”, “T-REZ HB125”, and “T-REZ OP501”; YS Resin series or YS Polyster series manufactured by Yasuhara Chemical Co., Ltd. such as “YS Resin PX1250”, “YS Resin PX1150”, “YS Resin PX1000”, “YS Resin PX1150 N”, “YS Resin TO125”, “YS Resin TO115”, “YS Resin TO105”, “YS Polyster T160”, “YS Polyster T145”, “YS Polyster T130”, “YS Polyster T115”, “YS Polyster T100”, and “YS Polyster UH115”; and FTR series manufactured by Mitsui Chemicals, Inc. such as “FTR 6100”, “FTR 6110”, and “FTR 6125”. The tackifier (D) may be used alone or in combination of two or more. Furthermore, a tackifier having a softening point of less than 90° C. can be blended within a range in which various intended physical properties are not impaired.

### [(E) Antioxidant]

The hot-melt adhesive composition of the present disclosure may contain an antioxidant (E). The inclusion of the antioxidant (E) may be suitable from the viewpoint of improving thermal stability and favorably exhibiting the effects of the present disclosure.

Examples of the antioxidant (E) include hindered phenols, polyphenols, bisphenols, phosphates, thioethers, hydrotalcites, benzimidazoles, and aromatic secondary amines.

Examples of representative commercially available products of the antioxidant (E) include Irganox series manufactured by BASF SE under the trade names of “Irganox 1010”, “Irganox 1035”, “Irganox 1076”, “Irganox 1098”, “Irganox 1330”, “Irganox 245”, “Irganox 259”, “Irganox 3114”, “Irganox 565”, “Irgafos 168”, and the like; and “ADEKA STAB” series manufactured by ADEKA CORPORATION under the trade names of “ADEKA STAB AO-20”, “ADEKA STAB AO-30”, “ADEKA STAB AO-40”, “ADEKA STAB AO-50”, “ADEKA STAB AO-60”, “ADEKA STAB AO-80”, “ADEKA STAB AO-330”, “ADEKA STAB PEP-8”, “ADEKA STAB PEP-36”, “ADEKA STAB HP-10”, “ADEKA STAB 2112”, “ADEKA STAB AO-412 S”, and the like. The antioxidant (E) may be used alone or in combination of two or more.

### [(F) Inorganic Filler]

The hot-melt adhesive composition of the present disclosure may contain an inorganic filler (F). Addition of the inorganic filler (F) can adjust adhesiveness, dripping property, specific gravity, and the like.

Examples of the inorganic filler (F) include calcium carbonate (such as ground calcium carbonate, surface-untreated calcium carbonate, surface-treated calcium carbonate (such as fatty acid-treated calcium carbonate), and acicular crystalline calcium carbonate), silica (such as fume silica, hydrophobic silica, and precipitated silica), talc, mica (isinglass), clay, chrysotile, wollastonite, carbon black, graphite, balloons (such as shirasu balloon, glass balloon, and silica balloon), inorganic fibers (such as glass fibers and metal fibers), titanium oxide, aluminum oxide, aluminum borate, silicon carbide, silicon nitride, potassium titanate, magnesium borate, titanium diborate, aluminum flakes, aluminum powder, and iron powder. The inorganic filler (F) may be used alone or in combination of two or more.

### [(G) Elastomer]

The hot-melt adhesive composition of the present disclosure may contain an elastomer (G). The elastomer (G) is a polymer exhibiting elasticity. The elastomer (G) may be thermosetting or thermoplastic, and is preferably thermoplastic. The elastomer (G) is distinguished from other components described herein in terms of crystallinity, Shore A hardness, and/or molecular weight, and the like. Typically, the elastomer (G) is not amorphous. Typically, the elastomer (G) has a Shore A hardness of less than 80. Typically, the elastomer (G) has a weight-average molecular weight of 40,000 or more.

The Shore A hardness of the elastomer (G) may be 20 or more, 30 or more, 40 or more, 50 or more, 60 or more, or 70 or more, and is preferably 40 or more. The Shore A hardness of the elastomer (G) may be less than 80, 75 or less, 70 or less, 65 or less, or 60 or less. The Shore A hardness of the elastomer (G) within the above-mentioned range is preferable from the viewpoint of more favorably exhibiting the effects of the present disclosure.

The MFR of the elastomer (G) may be 3 g/10 min or more, 5 g/10 min or more, 7 g/10 min or more, 10 g/10 min or more, 12 g/10 min or more, or 15 g/10 min or more, and is preferably 5 g/10 min or more, more preferably 7 g/10 min or more. The MFR of the elastomer (G) may be 40 g/10 min or less, 30 g/10 min or less, 20 g/10 min or less, 15 g/10 min or less, or 10 g/10 min or less. The MFR within the range equal to or more than the above-mentioned lower limit is preferable from the viewpoint of the low melt viscosity and coating stability. The MFR can be measured according to JIS K7210.

The weight-average molecular weight of the elastomer (G) may be 40,000 or more, 50,000 or more, 75,000 or more, 100,000 or more, 200,000 or more, 300,000 or more, or 500,000 or more, and is preferably 100,000 or more. The weight-average molecular weight of the elastomer (G) may be 5,000,000 or less, 2,000,000 or less, 1,500,000 or less, 1,200,000 or less, 1,000,000 or less, 800,000 or less, 600,000 or less, 400,000 or less, or 200,000 or less, and is preferably 1,000,000 or less, for example, 600,000 or less. The weight-average molecular weight within the above-mentioned range is preferable from the viewpoint of more favorably exhibiting the effects of the present disclosure.

Examples of the elastomer (G) include a rubber-based elastomer, an olefin-based elastomer, a styrene-based elastomer (for example, a hydrogenated or non-hydrogenated styrene-based elastomer), a vinyl chloride-based elastomer, a urethane-based elastomer, an ester-based elastomer, and an amide-based elastomer. From the viewpoint of compatibility, an olefin-based elastomer is preferable. The olefin-based elastomer may be an olefin-based elastomer having a repeating unit derived from propylene.

Examples of representative commercially available products of the elastomer (G) include TAFMER PN series manufactured by Mitsui Chemicals, Inc. under the trade names of “TAFMER PN-2070”, “TAFMER PN-3560”, and the like; INFUSE series manufactured by The Dow Chemical Co. under the trade names of “INFUSE 9807”, “INFUSE 9817”, “INFUSE 9990”, and the like; and Vistamaxx series manufactured by Exxon Mobil Corporation under the trade names of “Vistamaxx 6502”, “Vistamaxx 6202” and the like. The elastomer (G) may be used alone or in combination of two or more.

### [(H) Plasticizer]

The hot-melt adhesive composition of the present disclosure may contain a plasticizer (H). The plasticizer (H) is an oily substance such as a chain alkyl group-containing low molecular weight compound or an olefin oligomer. The plasticizer (H) may improve coating property and wettability to an adherend by lowering the viscosity of the hot-melt adhesive.

The weight-average molecular weight of the plasticizer (H) may be 100 or more, 300 or more, or 500 or more. The weight-average molecular weight of the plasticizer (H) may be less than 3,000, 2,500 or less, 20,000 or less, 1,500 or less, or 1,000 or less, and is preferably 2,000 or less. The weight-average molecular weight within the above-mentioned range is preferable from the viewpoint of more favorably exhibiting the effects of the present disclosure.

Examples of the plasticizer (H) include liquid paraffin, process oil, a phthalic acid-based plasticizer, a butene oligomer, a butadiene oligomer, a liquid ethylene-propylene oligomer, and liquid rubber. From the viewpoint of compatibility, a butene oligomer or a liquid ethylene-propylene oligomer is preferable.

Examples of representative commercially available products of the plasticizer (H) include POLYBUTENE series manufactured by NOF Corporation such as “NOF POLYBUTENE ON”, “NOF POLYBUTENE 015N”, “NOF POLYBUTENE 3N”, “NOF POLYBUTENE ION”, “NOF POLYBUTENE 30N”, and “NOF POLYBUTENE 200N”; and LUCANT series manufactured by Mitsui Chemicals, Inc. such as “LUCANT LX004”, “LUCANT LX010”, “LUCANT LX020”, “LUCANT LX100”, “LUCANT LX200”, “LUCANT LX400”, and “LUCANT LX900Z”. The plasticizer (H) may be used alone or in combination of two or more.

### [(1) Different Component]

The hot-melt adhesive composition of the present disclosure may contain a different component (I) as necessary in addition to the above-mentioned components. Examples of the different component (T) include colorants (for example, red iron oxide, titanium oxide, other coloring pigments, and dyes); organic solvents (methanol, ethanol, isopropyl alcohol, butanol, acetone, methyl ethyl ketone, ligroin, ethyl acetate, tetrahydrofuran, n-hexane, heptane, isoparaffin-based high-boiling point solvent, and the like); bonding agents (silane coupling agents such as vinyltrimethoxysilane, vinyltriethoxysilane, aminosilane, mercaptosilane, and epoxysilane, epoxy compounds such as glycidyl ether having a polyoxyalkylene backbone, and the like); vulcanization accelerators (guanidines, aldehyde-amines, aldehyde-ammonias, thiazoles, sulfenamides, thioureas, thiurams, dithiocarbamates, xanthates, and the like); vulcanization aids (long-chain fatty acids having 12 or more carbon atoms such as stearic acid, oleic acid, and palmitic acid, and metal oxides such as zinc oxide, magnesium oxide, and lead oxide); antiaging agents (hindered phenols, mercaptans, sulfides, dithiocarboxylates, thioureas, thiophosphates, thioaldehydes, and the like); ultraviolet absorbers/light stabilizers (benzotriazoles, hindered amines, and the like); thixotropic agents (colloidal silica, organic bentonite, fatty acid amide, hydrogenated castor oil, and the like), and other resins and polymer components (thermosetting resins, thermoplastic resins, and the like). These may be used alone, or in combination of two or more.

The hot-melt adhesive composition of the present disclosure may be solvent-free and does not have to contain a solvent.

The hot-melt adhesive composition of the present disclosure may be non-reactive and does not have to contain a reactive additive.

### [Composition]

The amount of the crystalline polyolefin (A) in the hot-melt adhesive composition may be 2.5 wt % or more, 5 wt % or more, 7.5 wt % or more, 10 wt % or more, 12.5 wt % or more, 15 wt % or more, 17.5 wt % or more, 20 wt % or more, 22.5 wt % or more, or 25 wt % or more, and is preferably 10 wt % or more, more preferably 15 wt % or more. The amount of the crystalline polyolefin (A) in the hot-melt adhesive composition may be 40 wt %/o or less, 35 wt % or less, 30 wt % or less, 25 wt % or less, 20 wt % or less, or 15 wt % or less, and is preferably 30 wt % or less.

The amount of the amorphous polyolefin (B) in the hot-melt adhesive composition may be 2.5 wt % or more, 5 wt % or more, 7.5 wt % or more, 10 wt % or more, 12.5 wt % or more, 15 wt % or more, 17.5 wt % or more, 20 w % or more, 22.5 wt % or more, or 25 wt % or more, and is preferably 10 wt % or more, more preferably 15 wt % or more. The amount of the amorphous polyolefin (B) in the hot-melt adhesive composition may be 40 wt % or less, 35 wt % or less, 30 wt % or less, 25 wt % or less, 20 wt %/o or less, or 15 wt % or less, and is preferably 30 wt % or less.

The amount of the polypropylene-based wax (C) in the hot-melt adhesive composition may be 10 wt % or more, 15 wt % or more, 20 wt % or more, 25 wt % or more, 30 wt % or more, 35 wt % or more, 40 wt % or more, 45 wt % or more, or 50 wt % or more, and is preferably 20 wt % or more, more preferably 30 wt % or more. The amount of the polypropylene-based wax (C) in the hot-melt adhesive composition may be 75 wt % or less, 70 wt %/o or less, 65 wt % or less, 60 wt % or less, 55 wt % or less, 50 wt % or less, or 45 wt % or less, and is preferably 65 wt % or less, more preferably 50 wt % or less.

The amount of the tackifier (D) in the hot-melt adhesive composition may be 2.5 wt % or more, 5 wt % or more, 7.5 wt % or more, 10 wt % or more, 12.5 wt % or more, 15 wt % or more, 17.5 wt % or more, 20 wt % or more, 22.5 wt % or more, or 25 wt % or more, and is preferably 10 wt % or more, more preferably 15 wt % or more. The amount of the tackifier (D) in the hot-melt adhesive composition may be 40 wt % or less, 35 wt % or less, 30 wt % or less, 25 wt % or less, 20 wt % or less, or 15 wt % or less, and is preferably 30 wt % or less.

The amount of the antioxidant (E) in the hot-melt adhesive composition may be 0.01 wt % or more, 0.05 wt % or more, 0.1 wt % or more, 0.3 wt % or more, 0.5 wt % or more, 0.75 wt % or more, or 1 wt % or more, and is preferably 0.1 wt % or more. The amount of the antioxidant (E) in the hot-melt adhesive composition may be 5 wt % or less, 4 wt % or less, 3 wt % or less, 2 wt % or less, or 1 wt % or less, and is preferably 3 wt % or less.

The amount of the inorganic filler (F) in the hot-melt adhesive composition may be 1 wt % or more, 2.5 wt % or more, 5 wt % or more, 7.5 wt % or more, 10 wt % or more, 12.5 wt % or more, or 15 wt % or more, and is preferably 2.5 wt % or more, more preferably 5 wt % or more. The amount of the inorganic filler (F) in the hot-melt adhesive composition may be 30 wt % or less, 25 wt % or less, 20 wt % or less, 15 wt % or less, 10 wt % or less, or 5 wt % or less.

The amount of the elastomer (G) in the hot-melt adhesive composition may be 0.5 wt % or more, 1 wt % or more, 2 wt % or more, 3 wt % or more, 4 wt % or more, 5 wt % or more, 6 wt % or more, 7 wt % or more, 8 wt % or more, 9 wt % or more, or 10 wt % or more, and is preferably 1 wt % or more, more preferably 3 wt % or more. The amount of the elastomer (G) in the hot-melt adhesive composition may be 25 wt % or less, 20 wt % or less, 15 wt % or less, 10 wt % or less, 7.5 wt % or less, 5 wt % or less, or 2.5 wt % or less, and is preferably 15 wt % or less, more preferably 10 wt % or less.

The amount of the different component (I) in the hot-melt adhesive composition of the present disclosure should be appropriately selected depending on the individual component. The total amount of the different component (I) in the hot-melt adhesive composition may be 0.1 wt % or more, 0.2 wt % or more, 0.5 wt % or more, 1 wt % or more, 2.5 wt % or more, or 5 wt % or more. The total amount of the different component (I) in the hot-melt adhesive composition may be 30 wt % or less, 25 wt % or less, 20 wt % or less, 15 wt % or less, 10 wt % or less, 7.5 wt % or less, 5 wt % or less, 2.5 wt % or less, or 1 wt % or less, and is preferably 20 wt % or less, more preferably 10 wt % or less. The amount of each of the different component (I) in the hot-melt adhesive composition may be 0.01 wt % or more, 0.05 wt % or more, 0.1 wt % or more, 0.3 wt % or more, 0.5 wt % or more, 0.75 wt % or more, 1 wt % or more, or 2.5 wt % or more. In addition, the amount of each of the different component (I) in the hot-melt adhesive composition may be 10 wt % or less, 7.5 wt % or less, 5 wt % or less, 2.5 wt % or less, or 1 wt % or less. The amount of the plasticizer (H) may be determined in conformity with the amount of the different component (I).

The combined amount of the crystalline polyolefin (A) and the amorphous polyolefin (B) in the hot-melt adhesive composition may be 5 wt % or more, 10 wt % or more, 15 wt % or more, 20 wt % or more, 25 wt % or more, 30 wt % or more, 35 wt % or more, 40 wt % or more, 45 wt % or more, or 50 wt % or more, and is preferably 20 wt % or more, more preferably 30 wt % or more. The combined amount of the crystalline polyolefin (A) and the amorphous polyolefin (B) in the hot-melt adhesive composition may be 80 wt % or less, 70 wt % or less, 60 wt % or less, 50 wt % or less, 40 wt % or less, or 30 wt % or less, and is preferably 60 wt % or less. The combined amount of the crystalline polyolefin (A) and the amorphous polyolefin (B) within the above-mentioned range is preferable from the viewpoint of favorably exhibiting the effects of the present disclosure.

The amount of the crystalline polyolefin (A) may be 15 parts by weight or more, 25 parts by weight or more, more than 50 parts by weight, 75 parts by weight or more, 100 parts by weight or more, 125 parts by weight or more, or 150 parts by weight or more, and is preferably 25 parts by weight or more, more preferably 60 parts by weight or more, and still more preferably 75 parts by weight or more with respect to 100 parts by weight of the amount of the amorphous polyolefin (B). The amount of the crystalline polyolefin (A) may be 500 parts by weight or less, 450 parts by weight or less, 400 parts by weight or less, 350 parts by weight or less, 300 parts by weight or less, 200 parts by weight or less, 150 parts by weight or less, 100 parts by weight or less, 75 parts by weight or less, or 50 parts by weight or less, and is preferably 400 parts by weight or less, more preferably 300 parts by weight or less, still more preferably 200 parts by weight or less with respect to 100 parts by weight of the amount of the amorphous polyolefin (B). The amount of the crystalline polyolefin (A) within the above-mentioned range is preferable from the viewpoint of favorably exhibiting the effects of the present disclosure.

The amount of the polypropylene-based wax (C) may be more than 50 parts by weight, 60 parts by weight or more, 70 parts by weight or more, 80 parts by weight or more, 90 parts by weight or more, 100 parts by weight or more, 110 parts by weight or more, or 120 parts by weight or more, and is preferably 60 parts by weight or more, more preferably 80 parts by weight or more, and still more preferably 90 parts by weight or more with respect to 100 parts by weight of the combined amount of the crystalline polyolefin (A) and the amorphous polyolefin (B). The amount of the polypropylene-based wax (C) may be 350 parts by weight or less, 300 parts by weight or less, 250 parts by weight or less, 200 parts by weight or less, 150 parts by weight or less, or 100 parts by weight or less, and is preferably 300 parts by weight or less, more preferably 250 parts by weight or less, still more preferably 200 parts by weight or less with respect to 100 parts by weight of the combined amount of the crystalline polyolefin (A) and the amorphous polyolefin (B). The amount of the polypropylene-based wax (C) within the above-mentioned range is preferable from the viewpoint of favorably exhibiting the effects of the present disclosure. When the amount of the polypropylene-based wax (C) is equal to or more than the above-mentioned lower limit, the crystallization promoting effect is improved, and the mold releasability may be improved. When the amount of the polypropylene-based wax (C) is equal to or less than the above-mentioned upper limit, adhesiveness may be improved.

The amount of the tackifier (D) may be 10 parts by weight or more, 20 parts by weight or more, 30 parts by weight or more, 40 parts by weight or more, 50 parts by weight or more, or 60 parts by weight or more, and is preferably 20 parts by weight or more, and more preferably 40 parts by weight or more with respect to 100 parts by weight of the combined amount of the crystalline polyolefin (A) and the amorphous polyolefin (B). The amount of the tackifier (D) may be 150 parts by weight or less, 125 parts by weight or less, 100 parts by weight or less, 75 parts by weight or less, 50 parts by weight or less, or 30 parts by weight or less, and is preferably 100 parts by weight or less, and more preferably 75 parts by weight or less with respect to 100 parts by weight of the combined amount of the crystalline polyolefin (A) and the amorphous polyolefin (B). The amount of the tackifier (D) within the above-mentioned range is preferable from the viewpoint of favorably exhibiting the effects of the present disclosure.

The amount of the inorganic filler (F) may be 5 parts by weight or more, 10 parts by weight or more, 15 parts by weight or more, 20 parts by weight or more, 25 parts by weight or more, or 30 parts by weight or more, and is preferably 10 parts by weight or more, and more preferably 20 parts by weight or more with respect to 100 parts by weight of the combined amount of the crystalline polyolefin (A) and the amorphous polyolefin (B). The amount of the inorganic filler (F) may be 75 parts by weight or less, 60 parts by weight or less, 50 parts by weight or less, 40 parts by weight or less, 30 parts by weight or less, or 20 parts by weight or less, and is preferably 60 parts by weight or less, and more preferably 40 parts by weight or less with respect to 100 parts by weight of the combined amount of the crystalline polyolefin (A) and the amorphous polyolefin (B). The amount of the inorganic filler (F) within the above-mentioned range is preferable from the viewpoint of favorably exhibiting the effects of the present disclosure.

The amount of the elastomer (G) may be 0.5 parts by weight or more, 1 part by weight or more, 3 parts by weight or more, 5 parts by weight or more, 7 parts by weight or more, 10 parts by weight or more, 12 parts by weight or more, or 15 parts by weight or more, and is preferably 3 parts by weight or more, more preferably 10 parts by weight or more with respect to 100 parts by weight of the combined amount of the crystalline polyolefin (A) and the amorphous polyolefin (B). The amount of the elastomer (G) may be 60 parts by weight or less, 50 parts by weight or less, 40 parts by weight or less, 30 parts by weight or less, 20 parts by weight or less, 15 parts by weight or less, or 10 parts by weight or less, and is preferably 40 parts by weight or less, more preferably 20 parts by weight or less with respect to 100 parts by weight of the combined amount of the crystalline polyolefin (A) and the amorphous polyolefin (B). The amount of the elastomer (G) within the above-mentioned range is preferable from the viewpoint of favorably exhibiting the effects of the present disclosure.

### [Physical Properties]

The hot-melt adhesive composition of the present disclosure may have a melt viscosity at 180° C., the general coating temperature of the hot-melt adhesive, of 5,000 mPa·s or more, 7,500 mPa·s or more, 10,000 mPa·s or more, 12,000 mPa·s or more, 15,000 mPa·s or more, 20,000 mPa·s or more, or 25,000 mPa·s or more, and the melt viscosity is preferably 10,000 mPa·s or more, and more preferably 15,000 mPa or more. The hot-melt adhesive composition of the present disclosure may have a melt viscosity at 180° C., the general coating temperature of the hot-melt adhesive, of 200,000 mPa·s or less, 150,000 mPa·s or less, 100,000 mPa·s or less, 50,000 mPa·s or less, 30,000 mPa·s or less, or 20,000 mPa·s or less, and the melt viscosity is preferably 150,000 mPa·s or less, and more preferably 100,000 mPa·s or less. The melt viscosity within the above-mentioned range is preferable because liquid dripping, coating unevenness, and the like do not occur when the hot-melt adhesive composition is applied to an adherend. The melt viscosity is a value measured under the conditions of a shear rate of 4.3 sec⁻¹ using a parallel plate type rheometer.

In the viscoelastic behavior of the hot-melt adhesive composition of the present disclosure during rapid cooling from 160° C. at a rate of 33° C. per minute, the storage elastic modulus at 60° C. may be 1×10⁴ Pa or more, 5×10⁴ Pa or more, 1×10⁵ Pa or more, 5×10⁵ Pa or more, 1×10⁶ Pa or more, 2×10⁶ Pa or more, or 3×10⁶ Pa or more, and is preferably 1×10⁵ Pa or more, more preferably 1×10⁶ Pa or more. In the viscoelastic behavior of the hot-melt adhesive composition of the present disclosure during rapid cooling from 160° C. at a rate of 33° C. per minute, the storage elastic modulus at 60° C. may be 1×10⁸ Pa or less, 5×10⁷ Pa or less, 1×10⁷ Pa or less, 5-10⁶ Pa or less, 3×10⁶ Pa or less, or 1×10⁶ Pa or less. The storage elastic modulus is a value measured under the conditions of a shear rate of 4.3 sec⁻¹ using a parallel plate type rheometer.

In the viscoelastic behavior of the hot-melt adhesive composition of the present disclosure during rapid cooling from 160° C. at a rate of 33° C. per minute, the temperature at which tan δ is 1 or less may be 30° C. or higher, 40° C. or higher, 50° C. or higher, 60° C. or higher, or 70° C. or higher, and is preferably 40° C. or higher, more preferably 60° C. or higher. In the viscoelastic behavior of the hot-melt adhesive composition of the present disclosure during rapid cooling from 160° C. at a rate of 33° C. per minute, the temperature at which tan δ is 1 or less may be 100° C. or lower, 90° C. or lower, 80° C. or lower, or 70° C. or lower, and is preferably 80° C. or lower. Note that tan δ is loss tangent and represents a ratio of a loss shear modulus (G″) to storage shear modulus (G′), G″/G′. The tan δ is a value measured under the conditions of a shear rate of 4.3 sec⁻¹ using a parallel plate type rheometer.

### <Method for Producing Hot-Melt Adhesive Composition>

The hot-melt adhesive composition of the present disclosure can be produced by mixing (A) to (C). For example, the hot-melt adhesive composition can be produced by collectively mixing (A) to (C) together with the different component as necessary using a heating/mixing stirrer.

### <Bonded Object and Method for Producing the Same>

The bonded object of the present disclosure includes a first base material, and a second base material bonded to the first base material with a hot-melt adhesive layer formed from a hot-melt adhesive composition interposed therebetween.

The method for producing the bonded object includes a step of applying the hot-melt adhesive composition in the present disclosure to one surface of the first base material to form a hot-melt adhesive layer, namely an application step; and a step of bonding the first base material to the second base material with the hot-melt adhesive layer interposed therebetween, namely a bonding step. The method may further include a curing step of crystallizing the hot-melt adhesive layer.

### [Base Material]

The base materials used as the first base material and the second base material are not particularly limited, and examples thereof include wooden materials; plastic materials such as polyolefin, polyvinyl chloride, polyurethane, polyester, and an epoxy resin; foams of the plastic material; rubber materials such as natural rubber and synthetic rubber; metal materials such as aluminum, iron, and stainless steel; and base materials made of inorganic materials such as ceramics. The shape of each base material is not particularly limited, and may be, for example, a sheet, foil, a plate, or a molded body. Each base material may be made of only one material or may be composed of two or more materials. The material of the surface of the base material on which the adhesive layer is provided is preferably a non-metal, more preferably a resin as described above, and still more preferably a polyolefin such as polypropylene.

### [Application Step]

In the application step, various hot-melt applicators can be used for an application method to the base material, and examples thereof include a method using a spray gun, c, a die coater, a roll coater, or the like. At the application to a base material, the hot-melt adhesive composition is usually heated at a temperature of 140° C. to 200° C. to be melted, and can be applied in a molten state. After being applied to a release film or a release paper, the hot-melt adhesive composition may be thermally transferred to another base material and used. After the application, the hot-melt adhesive layer may be solidified on the base material by cooling. The precoated base material (a base material containing an adhesive layer) obtained after the application step may be directly subjected to the subsequent molding step or may be stored and then subjected to the subsequent step.

### [Bonding Step]

In the bonding step, the hot-melt adhesive layer may be heated and activated to be melted again as necessary. Examples of the means for heating and activation include methods using heating, ultrasonic waves, high frequency waves, or microwaves, but are not particularly limited. The reactivation is preferably performed immediately before the pressure-bonding of the precoated base material to the second base material. The pressure-bonding of the precoated base material to the second base material is performed before the surface of the hot-melt adhesive composition layer solidifies. The pressure-bonding method is not particularly limited, and examples thereof include a press bonding process and a vacuum molding process. The second base material may or may not be heated. In addition, as long as the hot-melt adhesive composition layer is in a reactivated state, heating does not have to be performed at the time of pressure-bonding, but heating may be performed simultaneously with pressurization as necessary.

The temperature of the heat activation is preferably 100 to 200° C., for example, 100 to 180° C., more preferably 120° C. to 160° C. as the surface temperature of the hot-melt adhesive layer. The pressure during pressure-bonding for adhesion of the first base material to the second base material may be 0.01 to 0.5 MPa, and is preferably 0.01 to 0.20 MPa, more preferably 0.01 to 0.10 MPa. The time of pressure-bonding may be, for example, 1 to 300 seconds, and is preferably 1 to 60 seconds, and more preferably 10 to 30 seconds.

[Contact/Peeling Step with Mold]

The method for producing the bonded object of the present disclosure preferably includes a step of bringing a mold into contact with the hot-melt adhesive composition. In the hot-melt adhesive composition of the present disclosure, the mold and the hot-melt adhesive composition may be in contact with each other in the application step or the bonding step. For example, the method for producing the bonded object of the present disclosure can be suitably used in a vacuum forming process including a step of bringing a mold into contact with a hot-melt adhesive composition.

Examples of the raw material of the mold include, but are not limited to, metals and ceramics, and metals (for example, various alloys such as aluminum, iron, and stainless steel) are suitable.

The method for producing the bonded object of the present disclosure may further include a step of peeling the hot-melt adhesive layer formed from the hot-melt adhesive composition from the mold. The hot-melt adhesive layer may be peeled from the mold after cooling.

### <Automobile Interior Material and Method for Producing the Same>

### [Automobile Interior Material]

The automobile interior material of the present disclosure includes a molded article for an automobile interior and a surface material for an automobile interior (hereinafter also referred to as a “surface material”) bonded to the molded article for an automobile interior with a hot-melt adhesive layer formed from the hot-melt adhesive composition of the present disclosure interposed therebetween. The surface material may be a surface material derived from a surface material containing a hot-melt adhesive layer (a precoated surface material). Examples of the automobile interior material include a door trim, an instrument panel, a ceiling material, a rear tray, and a pillar.

The material of the molded article for an automobile interior is not particularly limited as long as it is used for an automobile interior material, and examples thereof include wood materials such as paper and wood; plastic materials such as polyolefin (polypropylene, polyethylene, an ethylene-propylene copolymer, and the like), polyvinyl chloride, polyurethane, polyester, an epoxy resin, nylon, polyester, polycarbonate, polyurethane, acrylic, ABS, and PCABS; rubber materials such as natural rubber and synthetic rubber; metal materials such as aluminum, iron, and stainless steel; and inorganic materials such as ceramics. The molded article for an automobile interior may be made of only one material or may be composed of two or more materials. The material of the surface of the molded article for an automobile interior on which an adhesive layer is provided is preferably the above-described non-metallic molded article material for an automobile interior, more preferably the above-described molded article material for an automobile interior made of a resin, and still more preferably polyolefins such as polypropylene.

The surface material is not particularly limited as long as it is made of a material used for an automobile interior material, and examples thereof include a plastic sheet of polyolefin, soft polyvinyl chloride, polyurethane, or the like; foams of the plastic; rubber sheets such as natural rubber and synthetic rubber; fabric materials such as a woven fabric and a nonwoven fabric; and metal foils such as aluminum. The surface material may be made of only one layer, or may include two or more layers of the same kind of material or different kinds of materials. Examples of the surface material including two or more layers include a sheet material with one or more layers of the plastic foam laminated onto one or more layers of the plastic sheet, the rubber sheet, the fabric material, the metal foil, or the like. Examples of such a laminate sheet material include soft polyvinyl chloride with polyolefin foam, an olefin-based thermoplastic elastomer with polyolefin foam, and a fabric with polyurethane foam. The material of the surface of the surface material on which an adhesive layer is provided is preferably the material for the above-described non-metallic surface material, more preferably the material for the above-described surface material made of a resin, and still more preferably polyolefins such as polypropylene.

### [Method for Producing Automobile Interior Material]

In the method for producing the automobile interior material of the present disclosure, the bonded object in the method for producing the bonded object may be an automobile interior material, the first base material in the method for producing the bonded object may be a surface material, and the second base material in the method for producing the bonded object may be a molded article for an automobile interior. Conversely, the bonded object may be an automobile interior material, the first base material may be a molded article for an automobile interior, and the second base material may be a surface material.

An example of the method for producing an automobile interior material includes the steps of applying the hot-melt adhesive composition of the present disclosure to a back surface of a surface material (for example, a foam layer surface of a surface material) to obtain a surface material containing a hot-melt adhesive layer (precoated surface material); and reactivating the obtained precoated surface material with a far-infrared heater or the like to melt the hot-melt adhesive layer, and then pressure-bonding the surface material to the molded article for an automobile interior with the hot-melt adhesive layer interposed therebetween. The method may further include a curing step of crystallizing the hot-melt adhesive layer. When thermal pressure-bonding can be performed in the step of pressure-bonding with the base material, reactivation by a far-infrared heater or the like may be unnecessary. The back surface of the surface material means a surface facing the molded article for an automobile interior when the surface material is bonded to the molded article for an automobile interior.

### EXAMPLES

Hereinafter, the present disclosure will be described more specifically with reference to examples and comparative examples, but the present disclosure is not limited thereto at all.

### Examples 1 to 13 and Comparative Examples 1 to 5

A hot-melt adhesive composition was obtained by mixing the components shown below in the composition shown in Table 1 below at 180° C. using a mixing stirrer (double-arm kneader SV-1-1 manufactured by Moriyama Works).

TABLE 1

| Blended | | | | | | | | | | | |
|---|---|---|---|---|---|---|---|---|---|---|---|
| component | | Ex. 1 | Ex. 2 | Ex. 3 | Ex. 4 | Ex. 5 | Ex. 6 | Ex. 7 | Ex. 8 | Ex. 9 | Ex. 10 |
| (A) | A-1 | 20 | | 10 | 10 | 10 | 10 | 20 | 20 | 20 | 20 |
| | A-2 | | 20 | 10 | 10 | 5 | 5 | | | | |
| (B) | B-1 | 20 | 20 | 20 | 20 | 20 | 20 | | 20 | 20 | 20 |
| | B-2 | | | | | | | 20 | | | |
| (C) | C-1 | 40 | 40 | 40 | 40 | 40 | 40 | 40 | 40 | 40 | 40 |
| | C-2 | | | | | | | | | | |
| (D) | D-1 | 20 | 20 | 20 | 20 | 20 | | 20 | | | |
| | D-2 | | | | | | 20 | | 20 | | |
| | D-3 | | | | | | | | | 20 | |
| | D-4 | | | | | | | | | | 20 |
| (E) | E-1 | 0.5 | 0.5 | 0.5 | 0.5 | 0.5 | 0.5 | 0.5 | 0.5 | 0.5 | 0.5 |
| | E-2 | 0.5 | 0.5 | 0.5 | 0.5 | 0.5 | 0.5 | 0.5 | 0.5 | 0.5 | 0.5 |
| (F) | F-1 | | | | 10 | 10 | 10 | | | | |
| (G) | G-1 | | | | | 5 | | | | | |
| | G-2 | | | | | | 5 | | | | |

| | | | | | | | | | | |
|---|---|---|---|---|---|---|---|---|---|---|
| Total | 101 | 101 | 101 | 111 | 111 | 111 | 101 | 101 | 101 | 101 |
| Melt viscosity | 18100 | 30900 | 19800 | 26700 | 27200 | 24000 | 8400 | 16000 | 16000 | 17700 |
| (m · Pas) | | | | | | | | | | |
| Storage elastic | 1.8E+6 | 3.5E+6 | 2.2E+6 | 2.9E+6 | 2.5E+6 | 4.0E+6 | 1.5E+6 | 1.7E+6 | 2.3E+6 | 3.8E+6 |
| modulus at | | | | | | | | | | |
| 60° C. during | | | | | | | | | | |
| rapid cooling | | | | | | | | | | |
| from molten | | | | | | | | | | |
| state (Pa) | | | | | | | | | | |
| Temperature at | 67 | 67 | 65 | 67 | 67 | 66 | 69 | 64 | 64 | 66 |
| which tanδ is | | | | | | | | | | |
| 1 or less (° C.) | | | | | | | | | | |
| Mold | good | good | good | good | good | good | good | good | good | good |
| releasability | | | | | | | | | | |
| Initial creep | 4 | 0 | 1 | 0 | 0 | 0 | 0 | 0 | 2 | 0 |
| (mm) 60° C. | BA100 | — | BA100 | — | — | — | — | — | BA100 | — |
| 200 g 5 min | | | | | | | | | | |
| Adhesive | 58.0 | 49.6 | 52.3 | 58.4 | 54.7 | 55.0 | 52.0 | 57.4 | 57.5 | 57.2 |
| strength | BA100 | BA100 | BA100 | BA100 | BA100 | BA100 | BA100 | BA100 | BA100 | BA100 |
| (N/25 mm) | | | | | | | | | | |
| Heat creep | 2 | 2 | 2 | 0 | 0 | 0 | 3 | 0 | 2 | 0 |
| resistance | BA100 | BA100 | BA100 | — | — | — | BA100 | — | BA100 | — |
| (mm) 80° C. | | | | | | | | | | |
| 100 g 24 hr | | | | | | | | | | |
| Heat creep | 4 | 5 | 2 | 1 | 2 | 2 | 3 | 1 | 4 | 0 |
| resistance | BA100 | BA100 | BA100 | BA100 | BA100 | BA100 | BA100 | BA100 | BA100 | — |
| (mm) 80° C. | | | | | | | | | | |
| 200 g 24 hr | | | | | | | | | | |

| Blended | | | | | Com. | Com. | Com. | Com. | Com. |
|---|---|---|---|---|---|---|---|---|---|
| component | | Ex. 11 | Ex. 12 | Ex. 13 | Ex. 1 | Ex. 2 | Ex. 3 | Ex. 4 | Ex. 5 |
| (A) | A-1 | 25 | 15 | 20 | | | 20 | 20 | 20 |
| | A-2 | | | | | | | | |
| (B) | B-1 | 15 | 25 | 20 | 20 | 40 | 20 | 20 | 20 |
| | B-2 | | | | | | | | |
| (C) | C-1 | 40 | 40 | 50 | 40 | 40 | 20 | | |
| | C-2 | | | | | | | | 40 |
| (D) | D-1 | 20 | 20 | 10 | 20 | 20 | 40 | 60 | 20 |
| | D-2 | | | | | | | | |
| | D-3 | | | | | | | | |
| | D-4 | | | | | | | | |
| (E) | E-1 | 0.5 | 0.5 | 0.5 | 0.5 | 0.5 | 0.5 | 0.5 | 0.5 |
| | E-2 | 0.5 | 0.5 | 0.5 | 0.5 | 0.5 | 0.5 | 0.5 | 0.5 |
| (F) | F-1 | | | | | | | | |
| (G) | G-1 | | | | 20 | | | | |
| | G-2 | | | | | | | | |

| | | | | | | | | |
|---|---|---|---|---|---|---|---|---|
| Total | 101 | 101 | 101 | 101 | 101 | 101 | 101 | 101 |
| Melt viscosity | 22500 | 14200 | 14400 | 66500 | 10100 | 46000 | 90500 | 8000 |
| (m · Pas) | | | | | | | | |
| Storage elastic | 2.2E+6 | 1.7E+6 | 2.2E+6 | 9.8E+5 | 9.3E+5 | 6.5E+3 | 2.1E+4 | 4.1E+4 |
| modulus at | | | | | | | | |
| 60° C. during | | | | | | | | |
| rapid cooling | | | | | | | | |
| from molten | | | | | | | | |
| state (Pa) | | | | | | | | |
| Temperature at | 66 | 69 | 72 | 69 | 64 | 48 | 20 or | 58 |
| which tanδ is | | | | | | | less | |
| 1 or less (° C.) | | | | | | | | |
| Mold | good | good | good | poor | poor | poor | poor | poor |
| releasability | | | | | | | | |
| Initial creep | 0 | 0 | 3 | 0 | 0 | 0 | 6 | 0 |
| (mm) 60° C. | — | — | BA100 | — | — | — | CF90/ | — |
| 200 g 5 min | | | | | | | BA10 | |
| Adhesive | 34.7 | 57.9 | 40.8 | 53.3 | 62.5 | 52.5 | 52.3 | 66.9 |
| strength | CF80/ | BA100 | CF60/ | BA100 | BA100 | BA100 | BA100 | BA100 |
| (N/25 mm) | BA20 | | BA40 | | | | | |
| Heat creep | 1 | 1 | 0 | 0 | 22 | 0 | F | 5 |
| resistance | BA100 | BA100 | — | — | CF80/ | — | CF100 | BA100 |
| (mm) 80° C. | | | | | BA20 | | | |
| 100 g 24 hr | | | | | | | | |
| Heat creep | 1 | 2 | 0 | 1 | F | 1 | F | F |
| resistance | BA100 | BA100 | — | BA100 | CF60/ | BA100 | CF100 | CF40/ |
| (mm) 80° C. | | | | | BA40 | | | BA60 |
| 200 g 24 hr | | | | | | | | |

[Component A]
A-1: VERSIFY 4200 (melting point: 84° C., Shore A hardness: 94, a propylene-ethylene copolymer) manufactured by The Dow Chemical Co.
A-2: VERSIFY 3000 (melting point: 108° C., Shore A hardness: 96, a propylene-ethylene copolymer) manufactured by The Dow Chemical Co.
[Component B]
B-1: VESTOPLAST 792 (softening point 108° C., a propylene-ethylene-butene copolymer) manufactured by Evonik Industries AG
B-2: RT 2585 (softening point: 132° C., a propylene-ethylene copolymer) manufactured by REXtac, LLC
[Component C]
C-1: VISCOL 660-P (softening point: 145° C., weight-average molecular weight: 8,000, polypropylene wax) manufactured by Sanyo Chemical Industries, Ltd.
C-2: SANWAX 171-P (softening point: 107° C., weight-average molecular weight: 9,500, polyethylene wax) manufactured by Sanyo Chemical Industries, Ltd.
[Component D]
D-1: ARKON P-140 (softening point: 140° C., hydrogenated petroleum-based) manufactured by Arakawa Chemical Industries, Ltd.
D-2: ARKON P-90 (softening point: 90° C., hydrogenated petroleum-based) manufactured by Arakawa Chemical Industries, Ltd.
D-3: YS Resin PN1150 (softening point: 115° C., terpene-based) manufactured by Yasuhara Chemical Co., Ltd.
D-4: YS Polyster T145 (softening point: 145° C., terpene phenol-based) manufactured by Yasuhara Chemical Co., Ltd.
[Component E]
E-1: Irganox 1010 (melting point: 110° C., hindered phenol-based) manufactured by BASF SE
E-2: Irgafos 168 (melting point: 183° C., phosphorus-based) manufactured by BASF SE
[Component F]
F-1: Calcium carbonate 300 mesh product manufactured by Shiraishi Calcium Kaisha, Ltd.
[Component G]
G-1: TAFMER PN-2070 (melting point: 140° C., Shore A hardness: 75, a propylene-based elastomer) manufactured by Mitsui Chemicals, Inc.
G-2: Vistamaxx 6202 (Vicat softening point: 48° C., Shore A hardness: 61, a propylene-based elastomer) manufactured by Exxon Mobil Corporation

Using the hot-melt adhesive compositions obtained in Examples 1 to 13 and Comparative Examples 1 to 4, measurements of melt viscosity and viscoelasticity during cooling were performed as follows. In addition, samples for an adhesion test were prepared as follows, and evaluation of mold peelability, initial creep, adhesive strength, and heat creep resistance was performed.

### [Melt Viscosity]

The measurement was performed under the conditions of a temperature of 180° C. and a shear rate of 4.3 sec⁻¹ using a parallel plate type rheometer. The results are shown in Table 1.

[Temperature at which Storage Elastic Modulus and tan δ During Rapid Cooling are 1 Or Less]

The viscoelastic behavior during rapid cooling from 160° C. at a rate of 33° C. per minute was measured under the conditions of a shear rate of 4.3 sec⁻¹ using a parallel plate type rheometer. The storage elastic modulus at 60° C. was recorded. In addition, the temperature at which tan δ was 1 or less was recorded. The results are shown in Table 1. The temperature at which tan δ is 1 or less can be used as an index of mold releasability. At the initial stage of measurement, the hot-melt adhesive is in a molten state, and thus viscosity acts more preferentially than elasticity does, and therefore, tan δ is 1 or more. However, upon rapid cooling, the hot-melt adhesive solidifies, and thus elasticity acts more preferentially than viscosity does. The temperature at which tan δ is 1 or less can be considered as a temperature at which the hot-melt adhesive solidifies.

### [Preparation of Sample 1 for Adhesion Test]

The adhesive was applied to the surface of a surface material (TPO/PPF, total thickness: 4 mm) at 180° C. using a roll coater so that a 100 g/m² adhesive layer may be obtained. Next, within one day after application of the adhesive, the surface material was heated with a far-infrared heater until the temperature reached 160° C. or higher, and then immediately superposed on an aluminum plate (thickness: 1 mm), and compressed under the conditions of 0.1 MPa and 15 seconds to obtain a laminate (sample 1 for an adhesion test).

### [Mold Peelability]

The peel strength (N/25 mm) at 90-degree peeling was measured using a push-pull gauge within 1 minute after the laminate (sample 1 for an adhesion test) was obtained.
good: 10 N/25 mm or more
poor: less than 10 N/25 mm

### [Preparation of Sample 2 for Adhesion Test]

The adhesive was applied to the surface of a surface material (TPO/PPF, total thickness: 4 mm) at 180° C. using a roll coater so that a 100 g/m² adhesive layer may be obtained. Next, within one day after application of the adhesive, the surface material was heated with a far-infrared heater until the temperature reached 160° C. or higher, and then immediately superposed on a PP board (thickness: 2 mm), and compressed under the conditions of 0.1 MPa and 15 seconds to obtain a laminate (sample 2 for an adhesion test).

### [Initial Creep]

After the laminate (sample 2 for an adhesion test) was obtained, a load of 200 g/25 mm was applied in a 90-degree angular direction in an atmosphere of 60° C., and the peeling length (mm) after 5 minutes was measured. The results are shown in Table 1.
BA: interfacial failure on a base material side
FB: material failure of a surface material
CF: cohesive failure of an adhesive

The number after the failure state indicates the percentage of the failure state.

### [Adhesive Strength]

The laminate (sample 2 for an adhesion test) was cured at 25° C. for 24 hours, and then the peel strength (N/25 mm) at 180-degree peeling was measured. The PP board was fixed with a jig, and the surface material was pulled and peeled. The measurement was performed at a peeling rate of 200 mm/min. The results are shown in Table 1.

### [Heat Creep Resistance]

After curing of the laminate (sample 2 for an adhesion test) at 25° C. for 24 hours, a load of 100 or 200 g/25 mm was applied in a 90-degree angular direction in an atmosphere of 80° C., and the peeling length (mm) after 24 hours was measured. The results are shown in Table 1.

### [Results]

In the sample of Examples 1 to 13, good mold releasability and adhesion properties were obtained. In Comparative Examples 1 and 2, since the crystalline polyolefin (A) was not blended, the mold releasability and/or the heat creep resistance was deteriorated. In Comparative Examples 3 and 4, since the blending amount of the polypropylene-based wax was out of the range of the present disclosure, the mold releasability was deteriorated. In Comparative Example 5, since polyethylene-based wax was used, the mold releasability and the heat creep resistance were deteriorated.

### INDUSTRIAL APPLICABILITY

The hot-melt adhesive composition of the present disclosure can be used, for example, as a solvent-free adhesive without discharging VOC, and has excellent adhesiveness to a resin base material, particularly an olefin-based material, and heat resistance. In addition, since workability that enables easy peeling from the mold is obtained (for example, when adhesion is performed by a vacuum forming process), the hot-melt adhesive composition can be suitably used as an adhesive for an automobile interior.

The invention claimed is:

1. A hot-melt adhesive composition comprising:
a crystalline polyolefin (A) having a Shore A hardness of 80 or more;
an amorphous polyolefin (B); and
a polypropylene-based wax (C),
wherein an amount of the polypropylene-based wax (C) is 60 parts by weight or more and 300 parts by weight or less with respect to 100 parts by weight of a combined amount of the crystalline polyolefin (A) and the amorphous polyolefin (B).

2. The hot-melt adhesive composition according to claim 1, wherein the crystalline polyolefin (A) has a melting point of 80° C. or higher.

3. The hot-melt adhesive composition according to claim 1, wherein the crystalline polyolefin (A) contains an ethylene-propylene copolymer.

4. The hot-melt adhesive composition according to claim 1, wherein the amorphous polyolefin (B) has a softening point of 100° C. or higher.

5. The hot-melt adhesive composition according to claim 1, wherein the amorphous polyolefin (B) includes at least one selected from the group consisting of an ethylene-propylene bipolymer and an ethylene-propylene-butene terpolymer.

6. The hot-melt adhesive composition according to claim 1, wherein the polypropylene-based wax (C) has a softening point of 130° C. or higher.

7. The hot-melt adhesive composition according to claim 1, comprising a tackifier (D).

8. The hot-melt adhesive composition according to claim 7, wherein the tackifier (D) has a softening point of 90° C. or higher.

9. The hot-melt adhesive composition according to claim 7, wherein the tackifier (D) includes at least one selected from the group consisting of a hydrogenated petroleum resin, a terpene resin, and a terpene phenol resin.

10. The hot-melt adhesive composition according to claim 1, comprising an antioxidant (E).

11. The hot-melt adhesive composition according to claim 1, comprising an inorganic filler (F).

12. The hot-melt adhesive composition according to claim 1, comprising an elastomer (G).

13. The hot-melt adhesive composition according to claim 1, having a melt viscosity at 180° C. of 15,000 mPa·s or more and 100,000 mPa·s or less.

14. The hot-melt adhesive composition according to claim 1, which is for an automobile interior material.

15. A precoated surface material for an automobile interior, the precoated surface material comprising: a surface material for an automobile interior; and a hot-melt adhesive layer formed from the hot-melt adhesive composition according to claim 1 and provided on a back surface of the surface material for an automobile interior.

16. An automobile interior material comprising: a molded article for an automobile interior; and the precoated surface material for an automobile interior according to claim 15 that is bonded to the molded article for an automobile interior with the hot-melt adhesive layer interposed therebetween.

17. A method for producing a bonded object,
the bonded object having a first base material and a second base material bonded to the first base material with a hot-melt adhesive layer formed from the hot-melt adhesive composition according to claim 1 interposed therebetween,
the method comprising a step of bringing a mold into contact with the hot-melt adhesive composition.
